(19) United States
(12) Patent Application Publication
(10) Pub. No.: US 2014/0019425 A1
(43) Pub. Date: Jan. 16, 2014

(54) FILE SERVER AND FILE MANAGEMENT METHOD

(71) Applicants: Koji Honami, Odawara (JP); Masahiro Shimizu, Odawara (JP)

(72) Inventors: Koji Honami, Odawara (JP); Masahiro Shimizu, Odawara (JP)

(73) Assignee: Hitachi, Ltd.

(21) Appl. No.: 13/522,899

(22) PCT Filed: Jul. 10, 2012
(86) PCT No.: PCT/JP2012/004443

§ 371 Date: Jul. 18, 2012

(51) Int. Cl. G06F 17/30

(52) U.S. Cl. 707/692; 707/E17.002; 707/E17.01

(57) ABSTRACT

The file server identifies two or more files, each including duplicated data among a plurality of files that have been stored into the logical storage device as a file group based on the file system information. The file server deletes copies of the duplicated data other than shared data that is one copy of the duplicated data included in the two or more files from the logical storage device. The file server makes a file, which is not a shared file of the file group, referring to the shared file that is a file configured by the shared data. The file server creates a group link that associates the m files that belong to the file group with each other.

### TECHNICAL FIELD

The present invention relates to a file management.

### BACKGROUND

A file server system has been publicly known in which a duplication of a file is cleared out by replacing at least one file that overlaps with one file in such a manner that the one file (a common file) is referred to. By this configuration, a utilization efficiency of a storage region of a storage apparatus can be improved for a file server system.

As a file management method for a file server system, Patent Literature 1 discloses a file management method in which a file that is provided with data that is common to a file that has been specified by a user is identified and an operation that is executed to a file that has been specified is reflected to other similar file.

### CITATION LIST

### Patent Literature

### [PTL 1]

Japanese Patent Application Laid-Open Publication No. 2011-210167

### SUMMARY OF INVENTION

### Technical Problem

For a technique that is disclosed in Patent Literature 1, although an operation that is executed to a file that has been specified by a user can be reflected to other files, a modification of a file other than a file that has been specified by a user cannot be reflected to other files. In other words, for a technique that is disclosed in Patent Literature 1, although an association of a file that has been specified by a user with a file that is provided with data that is common to a file that has been specified by a user can be executed, an association of all files that are provided with common data cannot be executed. Consequently, a processing is cumbersome in some cases.

### Solution of Problem

A file server manages the file system information that includes information that indicates a logical region and data of a file that has been stored into the logical region for a logical storage device that is configured by a plurality of logical regions. The file server identifies m files (where m is equal to or larger than 2). Each of the m files is provided with duplicated data that is data duplicated to (or correspond to or match with) each other among a plurality of files that have been stored into the logical storage device as a file group based on the file system information. The file server deletes duplicated data other than the shared data. The shared data is one copy of duplicated data among the duplicated data that is included in the m files from the logical storage device. The file server makes a file other than a shared file of the file group refer to the shared file that is a file configured by the shared data. The file server creates a group link that associates the m files that belong to the file group with each other. The logical storage device is based on a physical storage device. The physical storage device can be inside or outside the file server.

### Advantageous Effects of Invention

All files that are provided with duplicated data can be managed as a whole.

### BRIEF DESCRIPTION OF DRAWINGS

FIG. 1 is a view showing a hardware configuration of a computer system in accordance with an embodiment 1.

FIG. 2 is a view showing a hardware configuration of a computer system in which programs reside in the memory are illustrated, in accordance with an embodiment 1.

FIG. 3 is a view showing the details of a file system of a file management apparatus.

FIG. 4 is a view showing an example of an inode management table.

FIG. 5 is a view showing an example of a data configuration of a data block.

FIG. 6 is a view showing an example of metadata of a new type that is added to an inode management table.

FIG. 7 is a view showing a flow of a group link creation processing.

FIG. 8 is a view showing a part of an explanatory drawing of a group link creation processing prior to a clone source file is created.

FIG. 9 is a view showing a part of an explanatory drawing of a group link creation processing when a clone source file is created.

FIG. 10 is a view showing a part of an explanatory drawing of a group link creation processing when duplicated data of the clone target file is deleted.

FIG. 11 is a view showing a part of an explanatory drawing of a group link creation processing when a clone target file is set to refer to a data block of a clone source file.

FIG. 12 is a view showing a part of an explanatory drawing of a group link creation processing when a bidirectional group link is created.

FIG. 13 is a view showing a flow of a file group display processing.

FIG. 14 is a view showing an example of a file group list.

FIG. 15 is a view showing a flow of a file group deletion processing.

FIG. 16 is a view showing a part of an explanatory drawing of a file group deletion processing.

FIG. 17 is a view showing a part of an explanatory drawing of a file group deletion processing.

FIG. 18 is a view showing a part of an explanatory drawing of a file group deletion processing.

FIG. 19 is a view showing a flow of a first processing of a file group processing in accordance with an embodiment 2.

FIG. 20 is a view showing an example of a clone source file list.

FIG. 21 is a view showing a flow of a second processing of a file group display processing in accordance with an embodiment 2.

FIG. 22 is a view showing an example of a file group list.

FIG. 23 is a view showing a flow of a first processing of a file group display processing in accordance with an embodiment 3.

FIG. 24 is a view showing an example of a file group list.

FIG. 25 is a view showing a flow of a second processing of a file group processing in accordance with an embodiment 3.

FIG. 26 is a view showing an example of a file group list.

FIG. 27 is an explanatory drawing of a problem that is a premise of a file update processing.

FIG. 28 is a view showing a flow of a file update processing in accordance with an embodiment 4.

FIG. 29 is an explanatory drawing of a file update processing.

FIG. 30 is an explanatory drawing of a problem that is a premise of a shared data deletion processing.

FIG. 31 is a view showing a flow of a shared data deletion processing.

FIG. 32 is a view showing a part of an explanatory drawing of a shared data deletion processing.

FIG. 33 is a view showing a part of an explanatory drawing of a shared data deletion processing.

FIG. 34 is a view showing a part of an explanatory drawing of a shared data deletion processing.

### DESCRIPTION OF EMBODIMENTS

Some embodiments of the present invention will be described below in detail.

In the following descriptions, while a wide variety of information will be described in the expression of “xxx information” and “xxx table” in some cases, a wide variety of information can be represented by any data structure. In order to indicate that a wide variety of information is not depended on a data structure, the expression of “xxx table” can also be referred to as “xxx information”.

In the following descriptions, the processing will be described while a “program” is handled as a subject in some cases. In the case in which the program is executed by a processor (for instance, a CPU (Central Processing Unit)), the processor executes the predetermined processing by using a storage resource (such as a memory) and/or a communication interface device (such as a communication port) as it decides proper. Consequently, a subject of a processing can also be a processor. The processing that is described while a program is handled as a subject can also be a processing that is executed by a file server (for instance, a file storage apparatus described later or an archive apparatus). Moreover, the processor can include a hardware circuit that executes a part or a whole of a processing that is executed by a processor. A computer program can be installed from a program source to each of the computers. The program source can be a program distribution server or a storage medium for instance.

### Embodiment 1

An embodiment 1 of the present invention will be described below in detail with reference to the drawings. The present invention is not restricted to the embodiments that will be described below in detail.

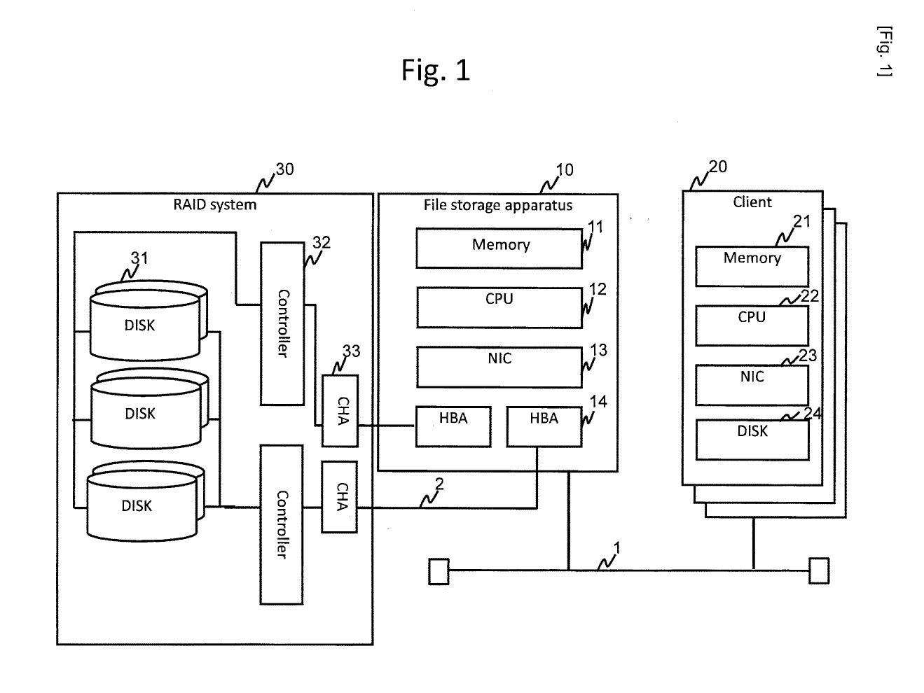

FIG. 1 is a view showing a hardware configuration of a computer system in accordance with an embodiment 1 of the present invention.

A computer system is provided with a client computer (hereafter referred to as a client) 20, a RAID (Redundant Arrays of Inexpensive Disks) system 30, and a file storage apparatus 10.

The file storage apparatus 10 and the client 20 are coupled to each other via a communication network (such as a LAN (Local Area Network)) 1. It is not necessary that the communication network 1 is a LAN.

The file storage apparatus 10 and the RAID system 30 are coupled to each other via a communication network (such as a SAN (Storage Area Network)) 2. It is not necessary that the communication network 2 is a SAN. The communication network 2 can be a LAN for instance.

The RAID system 30 is classified broadly into a controller part and a storage part. The controller part is provided with a controller 32 and a CHA (Channel Adaptor) 33. The storage part is provided with a DISK 31. The CHA 33 and the DISK 31 are coupled to the controller 32. The CHA 33 is an interface apparatus that is coupled to the file storage apparatus 10. Although there are two controllers 32 and two CHAs 33 in an example shown in the figure, only one controller 32 and one CHA 33 can also be disposed, or at least three controllers 32 and at least three CHAs 33 can also be disposed. The DISK 31 is a physical storage device of a disk type (such as an HDD (Hard Disk Drive). A physical storage device of other type (such as a flash memory device) can also be adopted as a physical storage device. Although there is a plurality of DISKs 31 in an example shown in the figure, only one DISK 31 can also be disposed, or a plurality of DISKs 31 can also configure at least one RAID group.

The RAID system 30 receives an I/O request of a block level that has been transmitted from the file storage apparatus 10 by the CHA 33 and executes an I/O to the appropriate DISK 31 based on a control of the controller 32.

The file storage apparatus 10 is an example of a file server, and is provided with a communication interface device and a controller that is coupled to the communication interface device. The controller is provided with a memory 11 and a CPU 12 for instance, and the communication interface device is provided with a NIC (Network Interface Card) 13 and an HBA (Host Bus Adaptor) 14. The CPU 12 is coupled to the memory 11, the NIC 13, and the HBA 14.

The NIC 13 is a communication interface device that is configured to communicate with the client 20.

The HBA 14 is a communication interface device that is configured to communicate with the RAID system 30. Although there are two HBAs 14 in an example shown in the figure, only one HBA 14 can also be disposed, or at least three HBAs 14 can also be disposed.

The memory 11 is a storage region that can be read or written directly by the CPU 22 (for instance, a RAM (Random Access Memory) and a ROM (Read Only Memory)). For the file storage apparatus 10, the CPU 12 reads a program (such as an OS (Operating System)) that is configured to control the file storage apparatus 10 onto the memory 11 and executes the program. The file storage apparatus 10 can also be provided with a storage resource of other type in addition to or as substitute for the memory 11.

The file storage apparatus 10 receives an I/O request of a file level from the client 20 via the NIC 13. The file storage apparatus 10 transmits an I/O request (an I/O request of a block level) for an I/O to a data block that stores data that configures a file that is specified by the I/O request to the RAID system 30 via the HBA 14.

The client 20 is provided with a memory 21, a CPU 22, a NIC 23, and a DISK 24. Moreover, an input/output apparatus can also be coupled to the client 20. The client 20 can also be provided with a storage resource of other type in addition to or as substitute for the memory 21 and/or the DISK 24.

For the client 20, the CPU 22 reads a program (a program that is configured to control the client, such as an OS) that has been stored into the DISK 24 onto the memory 21 and executes the program. For instance, in the case in which the CPU 22 executes the program, the client 20 transmits an I/O request of a file level to the file storage apparatus 10 via the NIC 23.

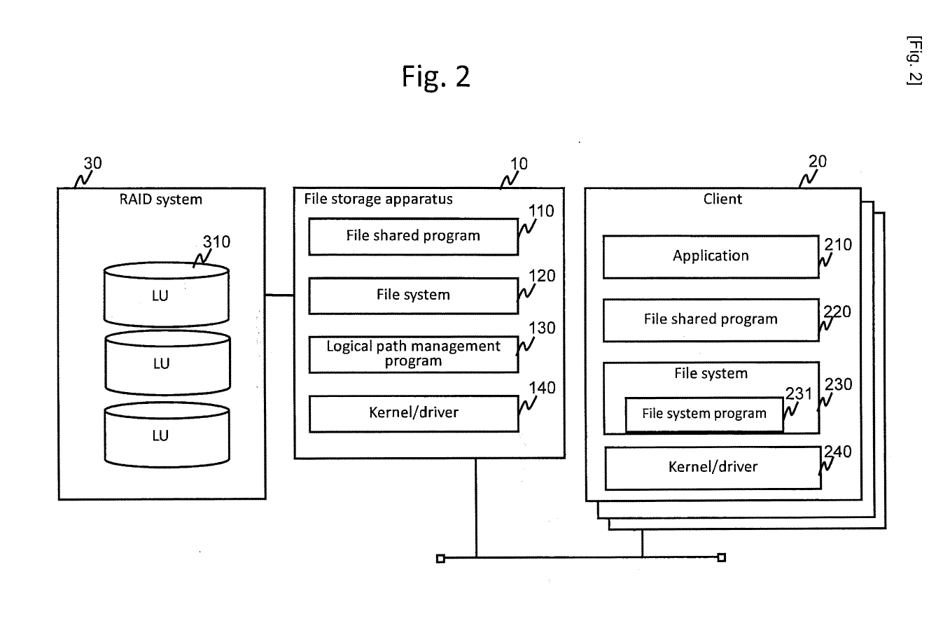

FIG. 2 is a view showing a hardware configuration of a computer system in accordance with an embodiment 1 of the present invention.

The RAID system 30 is provided with a plurality of LUs (Logical Units) 310. The LU 310 is a logical storage device. In the present embodiment, the LU 310 is a substantive LU 310 based on at least one DISK. However, an LU can also be a virtual LU that conforms to Thin Provisioning. The LU 310 is configured by a plurality of data blocks (storage regions). A file is stored into the LU 310. Moreover, the file system information described later can also be stored into the LU 310.

The memory 11 of the file storage apparatus 10 stores a file shared program 110, a file system 120, a logical path management program 130, and a Kernel/driver 140.

The file shared program 110 is a program that is configured to provide a file supply service to the client 20 by using a communication protocol such as a CIFS (Common Internet File System) and an NFS (Network File System).

The logical path management program 130 is a program that is configured to manage a logical path between the client 20 and the LU 310.

The Kernel/driver 140 is configured to execute a total control and a hardware peculiar control such as a schedule control of a plurality of programs (processes) that are operated on the file storage apparatus 10 and a handling of an interrupt from hardware.

The file system 120 will be described later.

The memory 21 of the client 20 stores an application 210, a file shared program 220, a file system 230, and a Kernel/driver 240.

The application 210 is software (an application program) that is configured to be used in accordance with a purpose of a work by the client 20. The file system 230 is provided with a file system program 231 that is configured to manage the file system information. The file shared program 220 and the Kernel/driver 240 are nearly equivalent to the file shared program 110 and the Kernel/driver 140 described above.

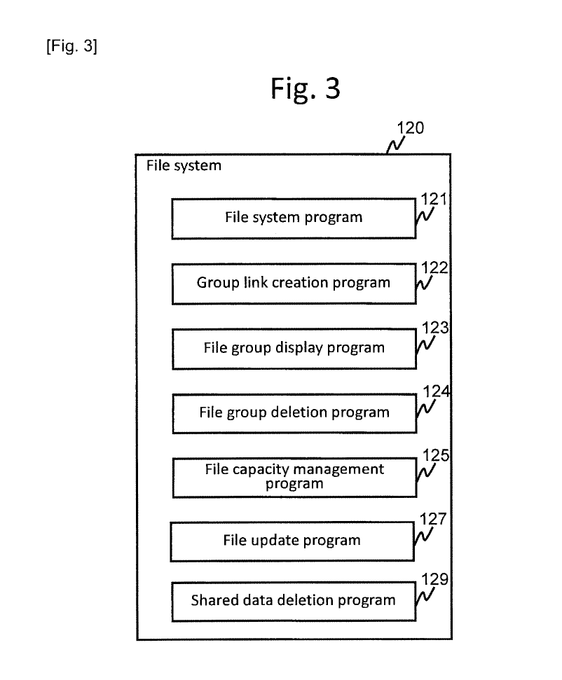

FIG. 3 is a view showing the details of a file system 120 of a file management apparatus 10.

The file system 120 is provided with a file system program 121, a group link creation program 122, a file group display program 123, a file group deletion program 124, a file capacity management program 125, a file update program 127, and a shared data deletion program 129.

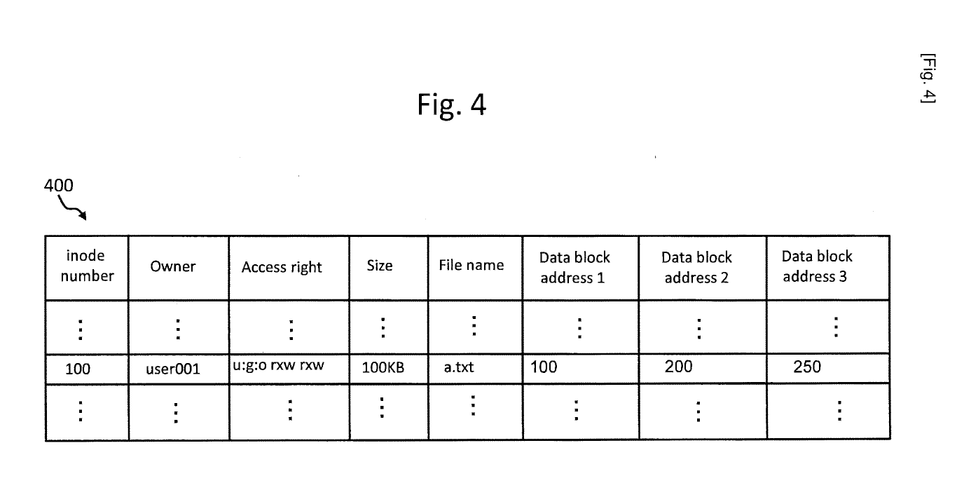

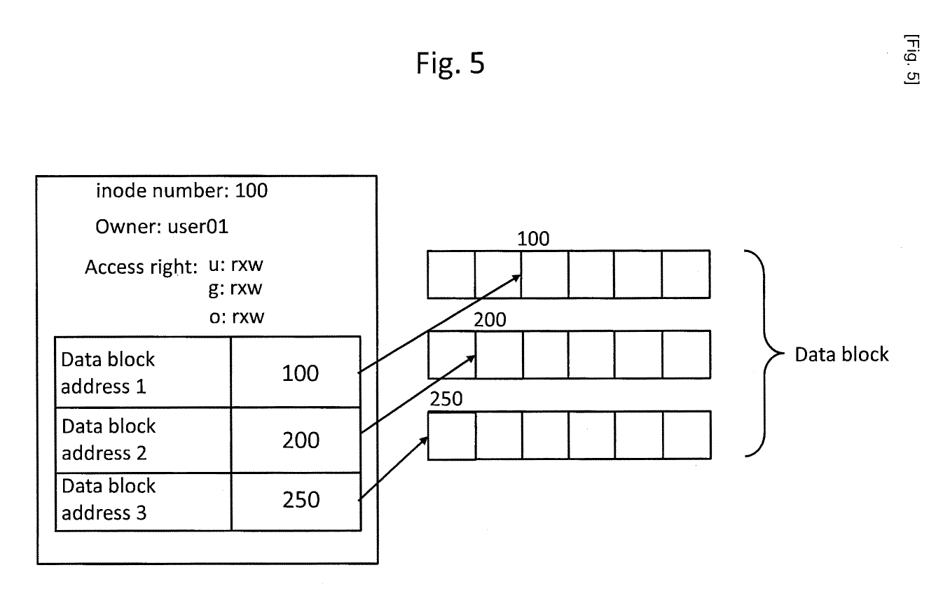

The file system program 121 is a program that is configured to manage the file system information. The file system information can be stored into the memory 11 and can be stored into the LU 310. The file system information includes the information that is related to each of the directories or files (for instance, the information that indicates a capacity and a location of a file). More specifically, the file system information includes the inode management table 400 shown in FIG. 4 for instance. The inode management table 400 is configured by a plurality of inodes (one line is corresponded to one inode). Each of the inode is configured by a plurality of attribute information (metadata). As a type of metadata, there can be mentioned for instance an owner of a file, an access right of a file, a file capacity, a file name, and a storage location of a file (data block addresses 1, 2, 3, . . . ). For a line that includes an inode number 100 for instance, it is found that a file is configured by data that is stored into the following data blocks (the data block in an LU as shown in FIG. 5:

(*) data in a data block of an address 100 (a data block that is identified by a data block address 1);
(*) data in a data block of an address 200 (a data block that is identified by a data block address 2); and
(*) data in a data block of an address 300 (a data block that is identified by a data block address 3).

The description is returned to FIG. 3. The group link creation program 122 is a program that is configured to delete the duplicated data and to manage a plurality of files that are provided with the duplicated data as a file group in the case in which data that is stored into a plurality of files is duplicated. More specifically for instance, the group link creation program sets data of one file to be shared data and deletes data that is duplicated to the shared data for other files among data that is duplicated to a plurality of files that configure a file group. The files are made to refer to the shared data. In the following descriptions, a file that is provided with the shared data is referred to as a clone source file and a file that refers to the shared data is referred to as a clone target file for a file group. Moreover in the following descriptions, a file that does not configure a file group, that is, a file that is not provided with data that is duplicated to other file is referred to as a normal file.

The file group display program 123 is a program that is configured to display the detailed information of a file group.

The file group deletion program 124 is a program that is configured to delete the file system information of a file group.

The file capacity management program 125 is a program that is configured to manage a data capacity of a file of a file group.

The file update program 127 is a program that is configured to execute a data update processing of the clone target file.

The shared data deletion program 129 is a program that is configured to delete a part or a whole of the shared data of the clone source file.

In the present embodiment, metadata of a new type is added to the inode management table.

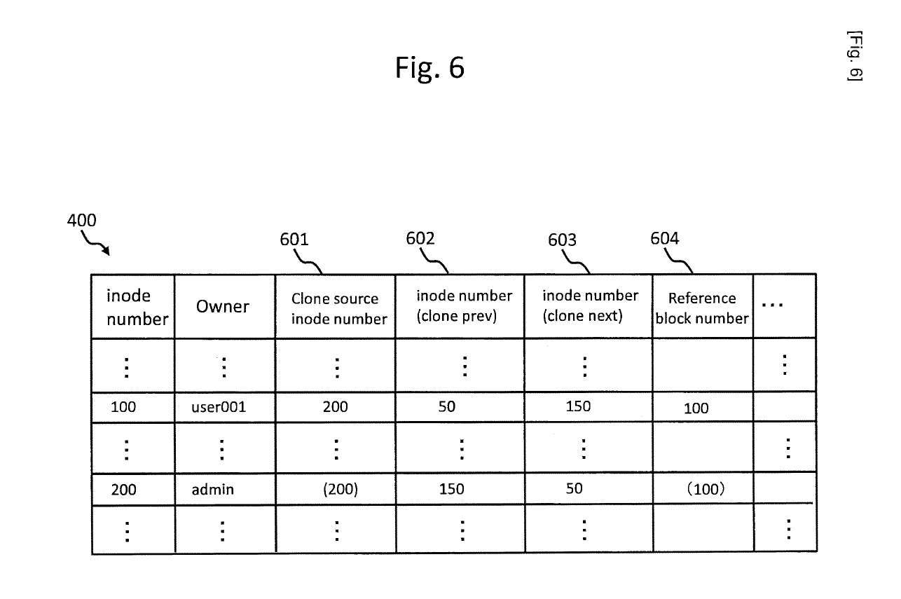

FIG. 6 is a view showing an example of metadata of a new type that is added to an inode management table 400.

There are metadata of a new type for every file (every inode) such as a clone source inode number 601, an inode number (clone prev) 602, and an inode number (clone next) 603. The following describes the metadata while using one file (referred to as a target file in the description of FIG. 6) as an example.

The clone source inode number 601 is an inode number of a clone source file. More specifically for instance, the clone source inode number 601 of a target file (an inode number is 100) is 200. The clone source inode number 601 of a clone source file (an inode number is 200) is set as “−”.

The inode number (clone prev) 602 is an inode number of a link source file of a target file (Mode) among a plurality of files that configure a file group.

The inode number (clone next) 603 is an inode number of a link destination file of a target file (Mode) among a plurality of files of a file group.

The processing that is executed in the present embodiments will be described in the following.

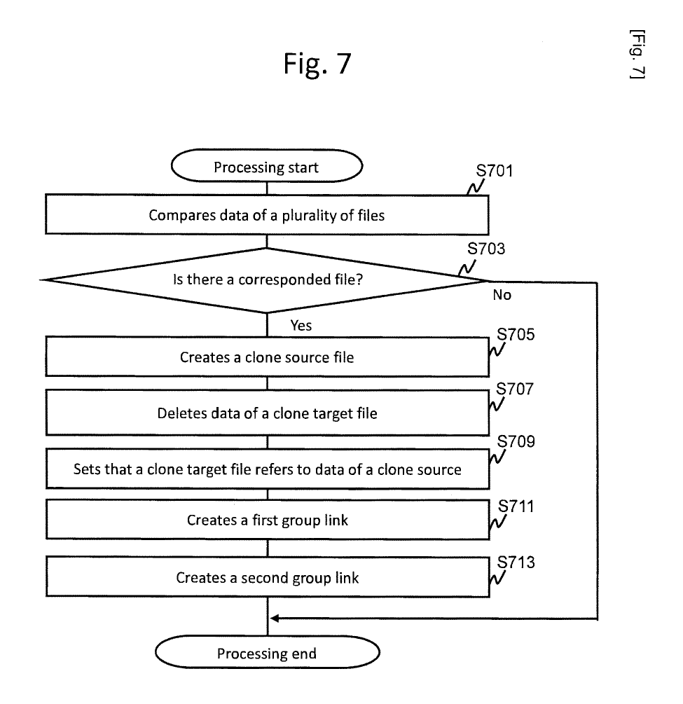

FIG. 7 is a view showing a flow of a group link creation processing. The group link creation processing is implemented in the case in which the group link creation program 122 is executed by the CPU 122.

In the step S701, the program 122 compares data of a plurality of files. More specifically for instance, the program 122 acquires a plurality of file system information and compares data in a data block that is identified from a data block address.

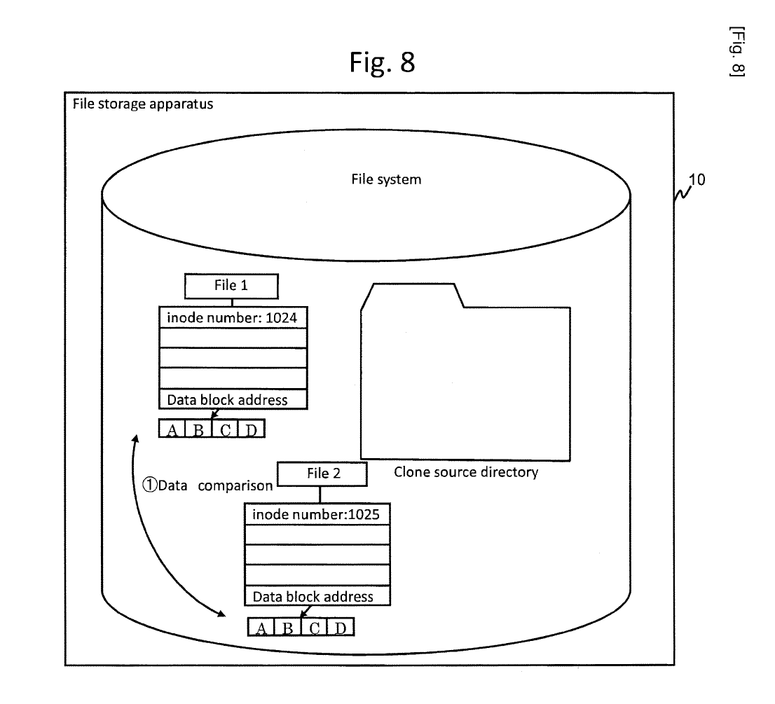

In the step S703, the program 122 judges whether or not there is a file in which data is corresponded (duplicated) to each other. Here, a file in which data is corresponded to each other is a file in which data of one data block or a plurality of continuous data blocks that are identified by the file system information that is included in a plurality of files is corresponded to each other for instance. In the case in which there is a file in which data is corresponded to each other (Yes for the step S703), the program 122 defines the plurality of files as one file group and proceeds to the processing of the step S705. On the other hand, in the case in which there is not a file in which data is corresponded to each other (No for the step S703), the program 122 terminates the processing. An example shown in FIG. 8 will be described more specifically. Since data (A, B, C, and D) in a data block that is identified from a data block address of a file 1 (inode number: 1024) and data (A, B, C, and D) in a data block that is identified from a data block address of a file 2 (inode number: 1025) are corresponded to each other, the program 122 sets the file 1 and file 2 to be one file group.

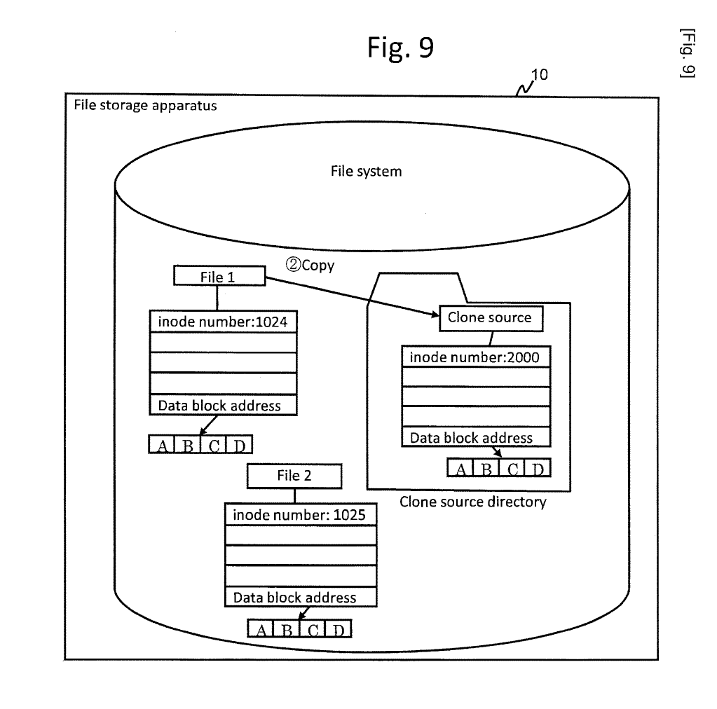

The description is returned to FIG. 7. In the step S705, the program 122 creates a clone source file. The program 122 can create a clone source file in a clone source directory. The clone source directory can also be a directory that is managed by a manager, that is, a directory that cannot be accessed by a user who does not have a manager authority. An example shown in FIG. 9 will be described more specifically. The program 122 creates the file system information in the clone source directory and adds an inode number 2000 to the inode management table 400. Moreover, the program 122 copies data that has been corresponded in the step S703 (hereafter referred to as duplicated data in the descriptions) (A, B, C, and D) to a data block (the copied data becomes shared data).

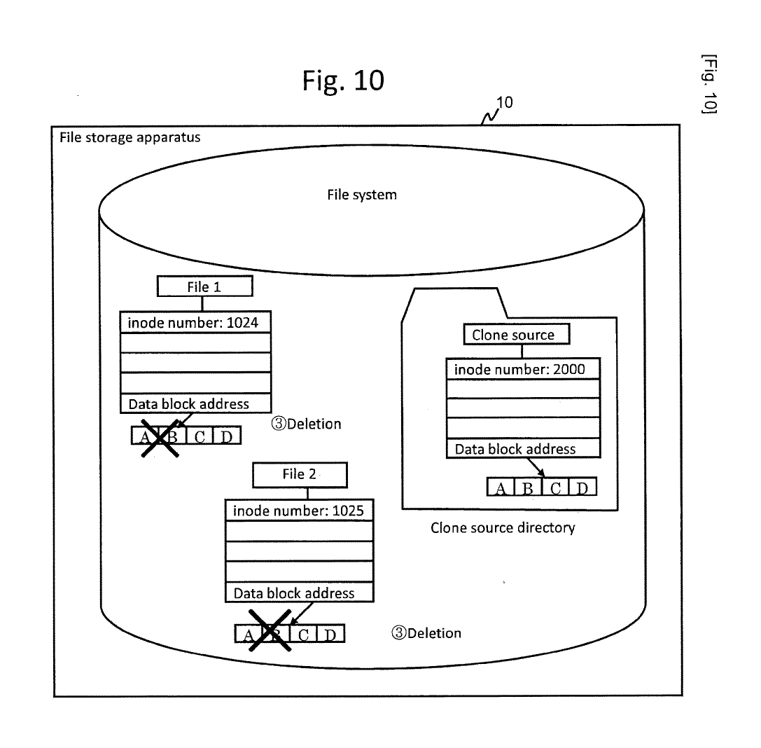

The description is returned to FIG. 7. In the step S707, the program 122 deletes the duplicated data of the clone target file. An example shown in FIG. 10 will be described more specifically. The program 122 deletes the duplicated data (A, B, C, and D) of the file 1 and the duplicated data (A, B, C, and D) of the file 2 that are the clone target files from the file system.

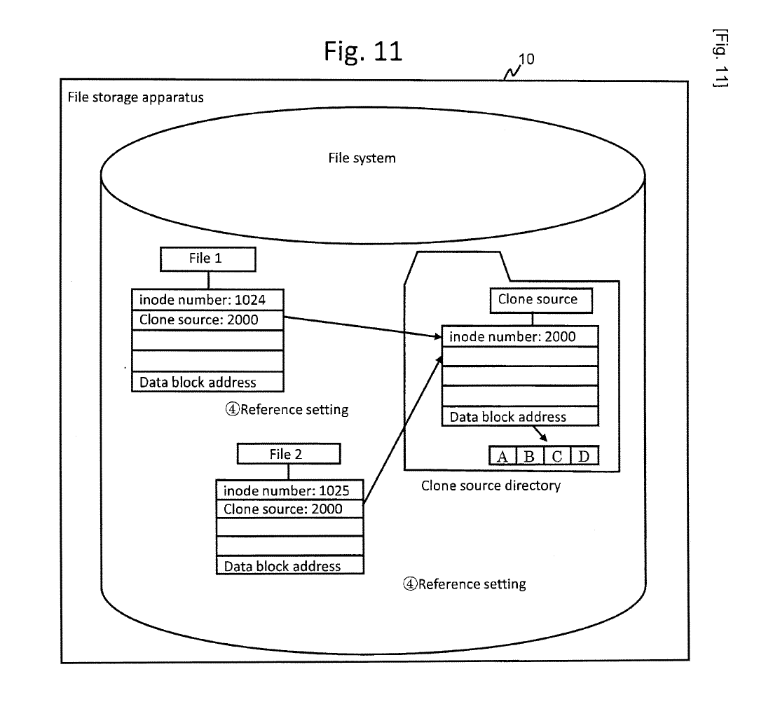

The description is returned to FIG. 7. In the step S709, the program 122 sets that a clone target file refers to a data block of a clone source file. More specifically, the program 122 sets an inode number of a clone source file to a clone source inode number 601 of the inode management table 400 of a target file for instance. An example shown in FIG. 11 will be described more specifically. A clone source inode number 2000 is set to a target file of “file 1”. Moreover, a clone source inode number 2000 is also set to a target file of “file 2”. The program 122 can also copy an address that has been stored into a data block address of a clone source file to a data block address of a clone target file.

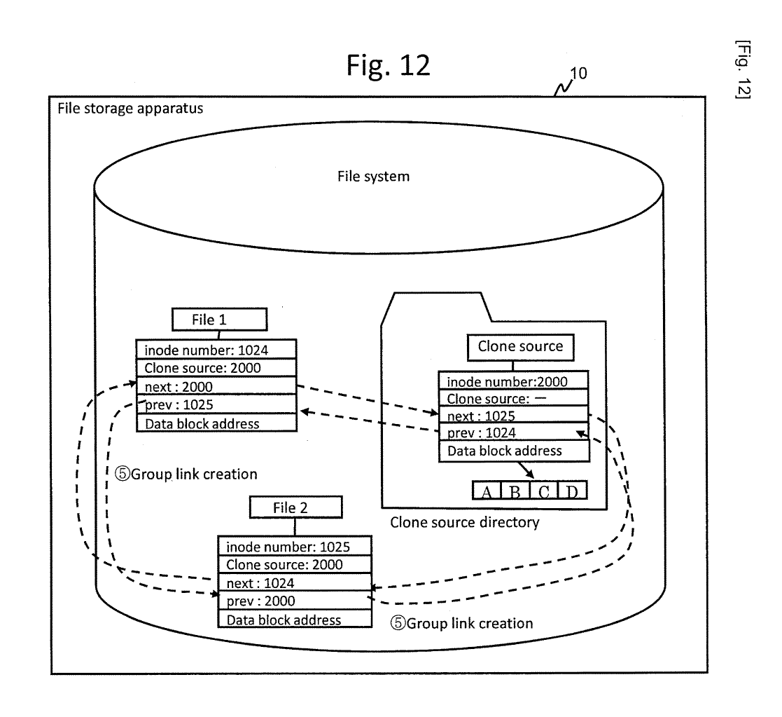

A group link creation processing will be described next. A group link creation processing is a processing for creating a group link in which a plurality of files in a file group are associated with each other. More specifically, a group link is a bidirectional circular link in which the n-th file is associated with the (n−1)-th file and the (n+1)-th file for a file group that is configured by m files for instance (m=1 in the case in which n+1=m). An example of a bidirectional circular link is illustrated in FIG. 12. In other words, a bidirectional group link includes a group link of one direction and a group link of the other direction.

The description is returned to FIG. 7 more specifically. In the step S711, the program 122 creates a group link of one direction (hereafter referred to as a first group link) for a file group. An example shown in FIG. 12 will be described more specifically. The program 122 executes the following processing:

(*) sets an inode number (2000) of a clone source to an inode number (clone next) 603 of the inode management table 400 of a file 1 (inode number: 1024);
(*) sets an inode number (1025) of a file 2 to an inode number (clone next) 603 of the inode management table 400 of a clone source (inode number: 2000); and
(*) sets an inode number (1024) of a file 1 to an inode number (clone next) 603 of the inode management table 400 of a file 2 (inode number: 1025).

In the step S713, the program 122 creates a group link of the other direction (hereafter referred to as a second group link) that is other from a direction of a group link that has been created in the step S711 for a file group.

More specifically, the file management program executes the following processing for instance:

(*) sets an inode number (1025) of a file 2 to an inode number (clone prev) 602 of the inode management table 400 of a file 1 (inode number: 1024);
(*) sets an inode number (2000) of a clone source file to an inode number (clone prev) 602 of the inode management table 400 of a file 2 (inode number: 1025); and
(*) sets an inode number (1024) of a file 1 to an inode number (clone prev) 602 of the inode management table 400 of a clone source file (inode number: 2000).

By the above group link creation processing, for a plurality of files that are provided with the duplicated data, one duplicated data is made to be the shared data and the other data is deleted (duplicated deletion). Thus, a storage region can be used in an effective manner and can be managed in a lump as a file group. In the case in which a file group is managed in a lump, a plurality of files that configure a file group can be displayed, and a plurality of files that configure a file group can be deleted in a lump as described in the following for instance. Moreover, in the case in which a group link is disposed not in one direction but bi-directionally, a desired file can be searched from the specified file in an effective manner.

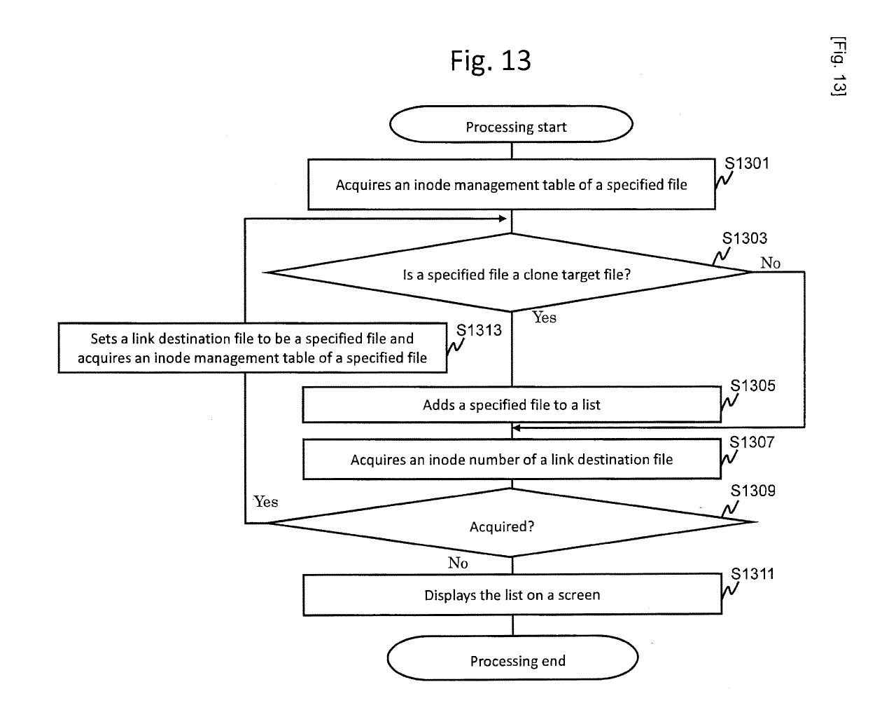

FIG. 13 is a view showing a flow of a file group display processing. The file group display processing is implemented in the case in which the file group display program 123 is executed by the CPU 12. The file group display processing is a processing for identifying and displaying a file group of a file that has been specified by a user or a manager (hereafter referred to as a user) via the client 10. In the descriptions of the figure, a file that has been specified by a user is referred to as a specified file.

In the step S1301, a program 123 acquires an inode management table 400 of a specified file.

In the step S1303, the program 123 judges whether or not a specified file is a clone target file. More specifically, the program 123 judges whether or not a number is set to a clone source inode number 601 of an inode management table 400 that has been acquired for instance. In the case in which a specified file is a clone target file as a result of the judgment (Yes for the step S1303), the program 123 proceeds to the processing of the step S1305. On the other hand, in the case in which a specified file is not a clone target file as a result of the judgment (No for the step S1303), the program 123 proceeds to the processing of the step S1307.

In the step S1305, the program 123 adds a specified file to a list. More specifically, the program 123 stores a file name and an inode number of the specified file into the memory 11 in order to display the file name and the inode number on the file group list for instance.

In the step S1307, the program 123 acquires an inode number of a link destination file of the specified file. More specifically, the program 123 refers to the inode management table 400 and acquires an inode number (clone next) 603 of the specified file.

In the step S1309, the program 123 judges whether or not an inode number of a link destination file of the specified file has been acquired. In the case in which an inode number of a link destination file of the specified file has not been acquired as a result of the judgment or the acquired inode number is an inode number that has already been acquired (No for the step S1309), the program 123 proceeds to the processing of the step S1311. On the other hand, in the case in which an inode number of a link destination file of the specified file has been acquired as a result of the judgment (Yes for the step S1309), the program 123 proceeds to the processing of the step S1313.

In the step S1313, the program 123 sets a link destination file to be a specified file, acquires an inode management table 400 of the specified file, and proceeds to the processing of the step S1303.

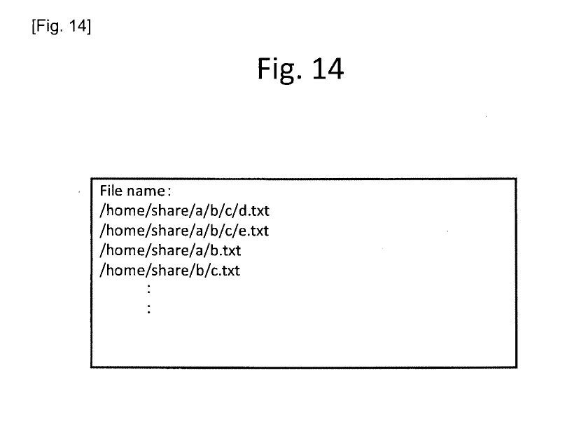

In the step S1311, the program 123 displays the file group list. An example of the file group list is shown in FIG. 14. Although only file name is displayed in the example shown in the figure, other information such as an inode number can also be displayed.

By the file group display processing described above, a user can know all files that belong to a file group.

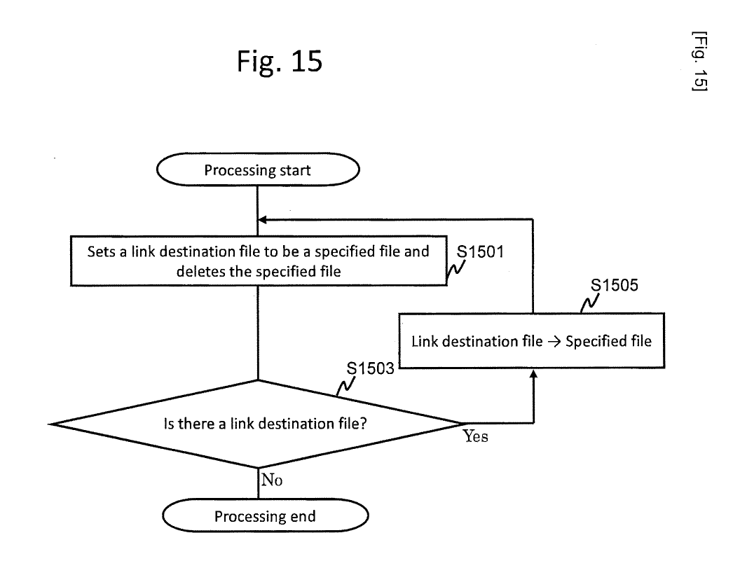

FIG. 15 is a view showing a flow of a file group deletion processing. The file group deletion processing is implemented in the case in which the file group deletion program 124 is executed by the CPU 12. The file group deletion processing is a processing for deleting all files that belong to a file group of a file that has been specified by a user via the client 10. In the descriptions of the figure, a file that has been specified by a user is referred to as a specified file.

In the step S1501, a program 124 acquires a link destination file of the specified file and deletes the specified file.

In the step S1503, the program 124 judges whether or not a link destination file of the specified file has been acquired. In the case in which a link destination file of the specified file has been acquired as a result of the judgment (Yes for the step S1503), the program 124 proceeds to the processing of the step S1505. On the other hand, in the case in which a link destination file of the specified file has not been acquired as a result of the judgment (No for the step S1503), the program 124 terminates the processing.

In the step S1505, the program 124 sets the acquired link destination file to be a specified file and proceeds to the processing of the step S1501.

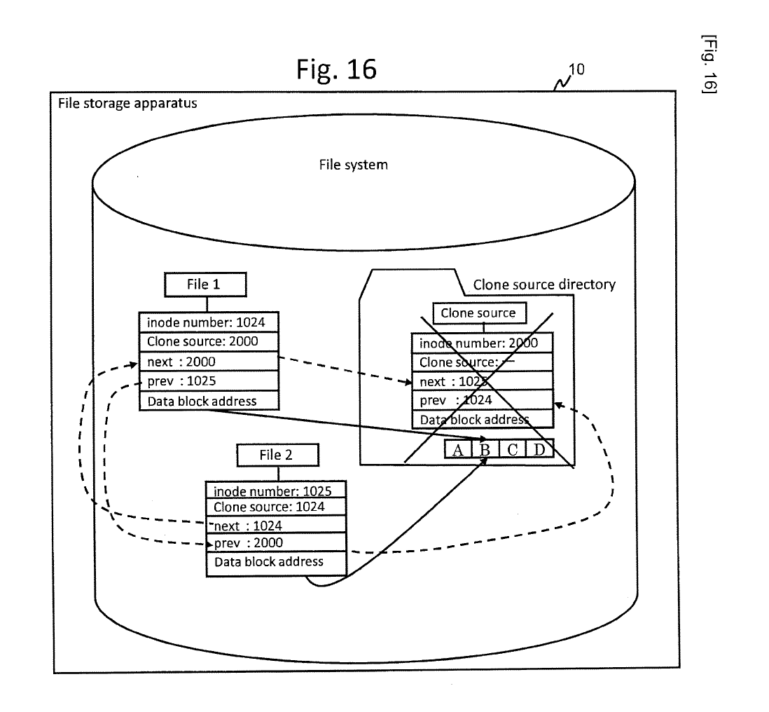

The following describes a concrete example of a file group deletion processing with reference to FIG. 16 to FIG. 18.

FIG. 16 is referred to. In the first step S1501, the program 124 refers to the inode management table 400 of a specified file (an inode number: 2000) and acquires an inode number of a link destination file (an inode number (clone next) 603 (an inode number: 1024)). Moreover, the program 124 deletes the file system information of the specified file. In the example shown in the figure, since the specified file is a clone source file, the shared data (data block) that is identified by the file system information is also deleted. Since a link destination file has been acquired (step S1503), the program 124 sets the link destination file to be a specified file (step S1505).

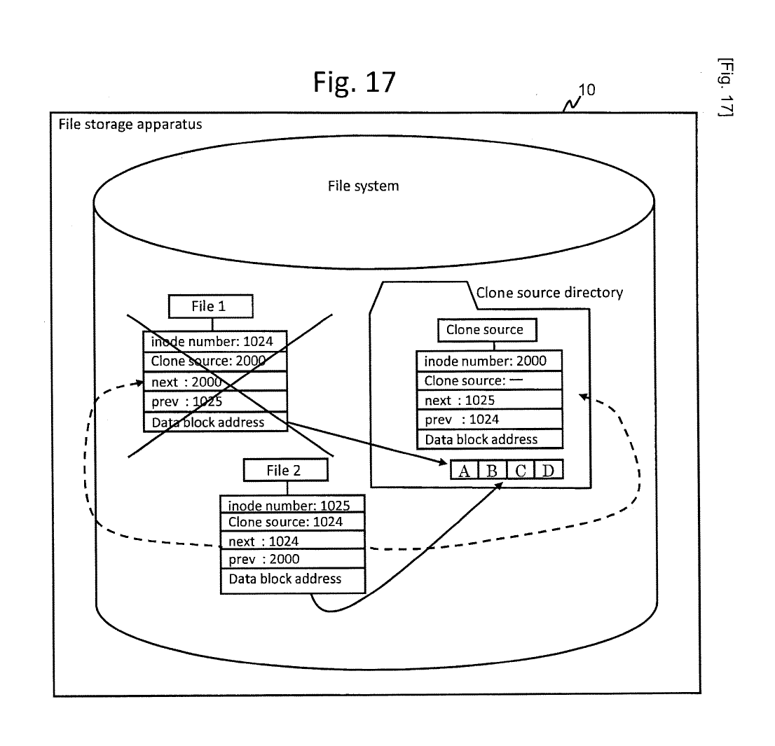

FIG. 17 is referred to. In the next step S1501, the program 124 refers to the inode management table 400 of a specified file (an inode number: 1024) and acquires an inode number of a link destination file (an inode number (clone next) 603 (an inode number: 1025)). Moreover, the program 124 deletes the file system information of the specified file. Since a link destination file has been acquired (step S1503), the program 124 sets the link destination file to be a specified file (step S1505).

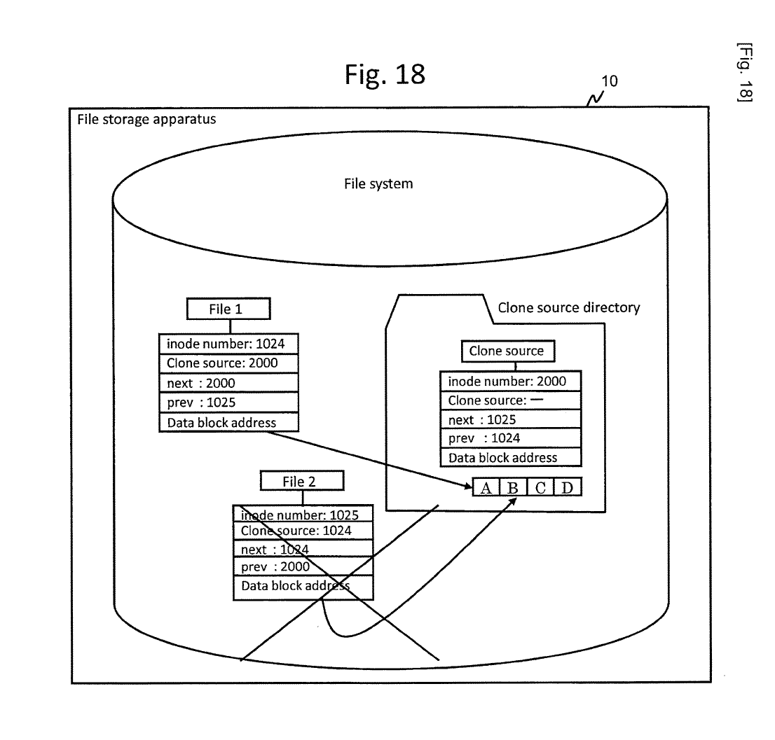

FIG. 18 is referred to. In the further next step S1501, the program 124 refers to the inode management table 400 of a specified file (an inode number: 1025) and acquires an inode number of a link destination file (an inode number (clone next) 603 (an inode number: none)). Moreover, the program 124 deletes the file system information of the specified file (a super block, an inode management table, and a data block). Since a link destination file has not been acquired (step S1503), the program 124 terminates the processing.

By the above file group deletion processing, it is possible that all file groups to which a file that has been specified by a user belongs are deleted. Although the clone source file is specified in the above description, it is also possible that a clone target file is specified.

Although a file that is a target that is deleted in the next to the specified file is a link destination file in the present embodiment, it is also possible that the file is a link source file.

### Embodiment 2

Next, an embodiment 2 of the present invention will be described in detail with reference to the drawings. In this case, the points that are different from the embodiment 1 will be described in large part, and the descriptions of the points that are common to the embodiment 1 will be omitted or simplified.

The file group display processing in accordance with the embodiment 2 is composed of the following two processes:

(*) a first processing in which a user specifies a range of a capacity of a clone source file via the client 10 and the clone source file that is provided with a capacity in the specified range is displayed; and
(*) a second processing in which a user specifies one clone source file from the clone source files that have been displayed and the total capacity of a file group to which the specified clone source file belongs is displayed.

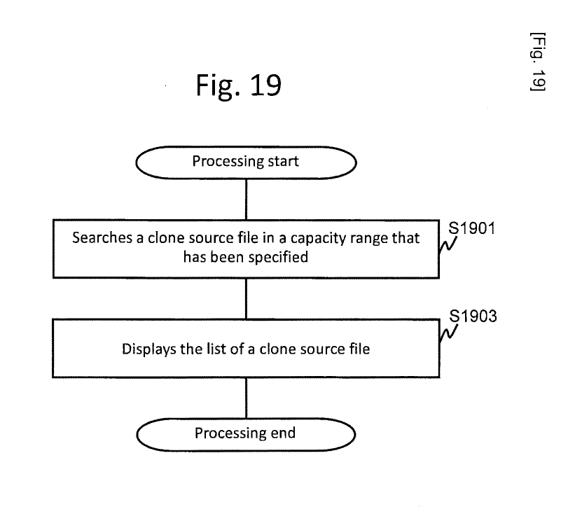

FIG. 19 is a view showing a flow of a first processing of a file group processing in accordance with an embodiment 2 of the present invention.

In the step S1901, a program 123 searches a clone source file that has been specified via the client 10. More specifically, the program 123 displays a display screen that is configured to specify a capacity range of a clone source file for a user on an input/output apparatus of the client 10. For a capacity range for instance, a lower limit capacity and an upper limit capacity of a clone source file can be specified. Moreover, the program 123 searches a clone source file in a capacity range that has been specified by a user.

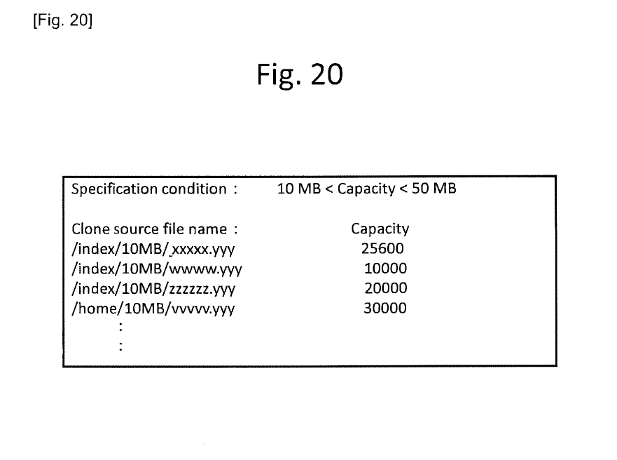

In the step S1903, a program 123 displays a clone source file list in a capacity range that has been specified and terminates the processing. In the clone source file list, a file name of a clone source file in a capacity range that has been specified and a file capacity are displayed as shown in FIG. 20 for instance.

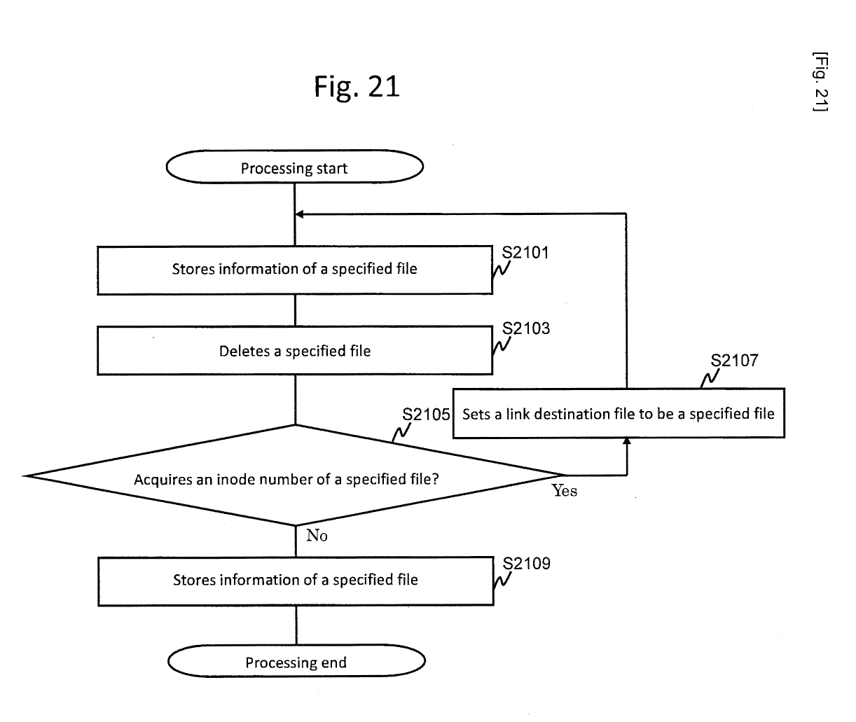

FIG. 21 is a view showing a flow of a second processing of a file group display processing in accordance with an embodiment 2 of the present invention.

In the step S2101, the program 123 adds a file that has been specified from the clone source file list by a user (hereafter referred to as a specified file in the description) to a file group list and acquires a link destination file. More specifically, the program 123 refers to the inode management table 400 of the specified file and adds an inode number, a file name, and a file capacity of the specified file to the clone source file list to store the inode number, the file name, and the file capacity. The program 123 then acquires an inode number (an inode number (clone next) 603) of the link destination file.

In the step S2103, the program 123 deletes the file system information of the specified file.

In the step S2105, the program 123 judges whether or not an inode number of a link destination file of the specified file has been acquired. In the case in which an inode number of a link destination file of the specified file has been acquired as a result of the judgment (Yes for the step S2105), the program 123 proceeds to the processing of the step S2107. On the other hand, in the case in which an inode number of a link destination file of the specified file has not been acquired or the acquired inode number is an inode number that has already been acquired as a result of the judgment (No for the step S2105), the program 123 proceeds to the processing of the step S2109.

In the step S2107, the program 123 sets the link destination file to be the next specified file and proceeds to the processing of the step S2101.

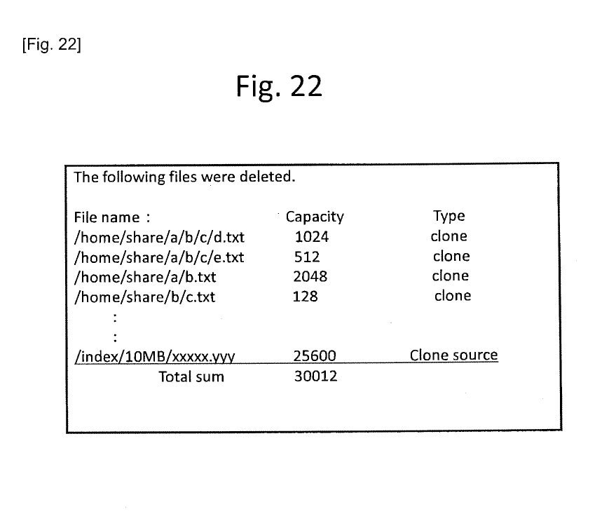

In the step S2109, a program 123 displays a file group list on an input/output apparatus of the client 10. An example of a file group list is shown in FIG. 22 for instance. In the example shown in the figure, a file name, a file capacity, a type that indicates a clone target file or a clone source file, the total sum of the file capacity of the entire file group are displayed. In addition, other information such as an inode number can also be displayed.

For the file group display processing in accordance with the present embodiment, in the case in which a user specifies a clone source file of a data capacity in a certain range, the user can know a capacity of each file of a file group to which the clone source file belongs and the total capacity of the file group. By this configuration, a file of a capacity in accordance with a necessity can be identified for ensure a free capacity.

### Embodiment 3

Next, an embodiment 3 of the present invention will be described in detail with reference to the drawings. In this case, the points that are different from the embodiment 1 (and 2) will be described in large part, and the descriptions of the points that are common to the embodiment 1 (and 2) will be omitted or simplified.

The file group display processing in accordance with the embodiment 3 is composed of the following two processes:

(*) a first processing in which a user specifies an arbitrary file via the client 10 and a type of the specified file is displayed; and
(*) a second processing in which a user specifies an arbitrary clone source file based on the display, and a capacity of each file that belongs to a file group of the specified clone target file and the total capacity of the file group are displayed.

In the following descriptions, a clone source file is not included in a file that is specified by a user in the first processing. By this configuration, this processing is effective in the case in which a person who does not have a manager authority tries to display a file group. However, this processing is not restricted to an example that will be described in the following.

An example of a file group display processing in accordance with the present embodiment will be described in the following.

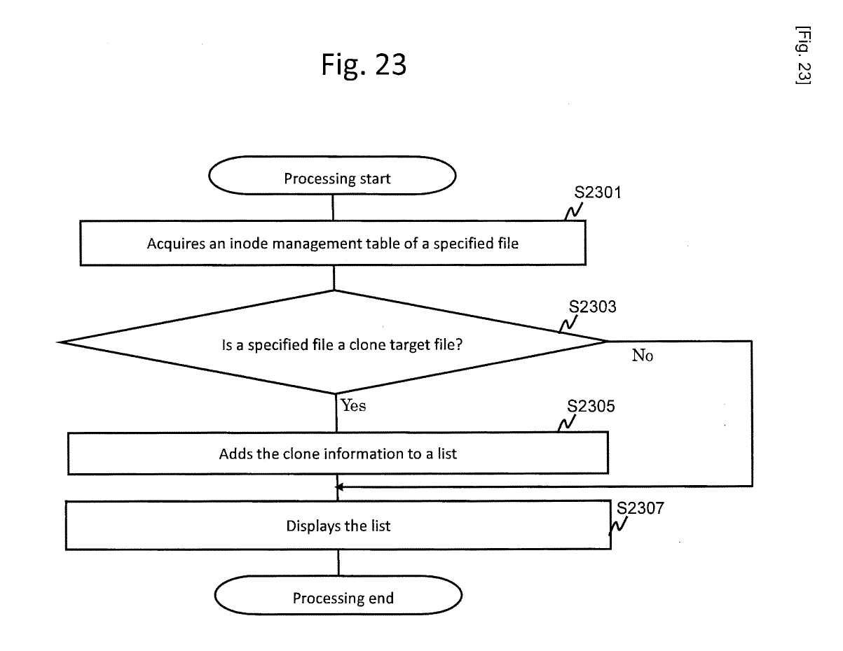

FIG. 23 is a view showing a flow of a first processing of a file group display processing in accordance with an embodiment 3 of the present invention.

In the step S2301, the program 123 acquires an inode management table 400 of an arbitrary file that has been specified by a user (hereafter referred to as a specified file in the description of this figure).

In the step S2303, the program 123 judges whether or not a specified file is a clone target file. More specifically, the program 123 judges whether a number of a clone source file has been set to a clone source inode number 601 of an inode management table 400 that has been acquired or a number of a clone source file has not been set to a clone source inode number 601 of an inode management table 400 that has been acquired (that is, the specified file is a normal file) for instance. In the case in which a specified file is a clone target file as a result of the judgment (Yes for the step S2303), the program 123 proceeds to the processing of the step S2305. On the other hand, in the case in which the specified file is a normal file as a result of the judgment (No for the step S2303), the program 123 proceeds to the processing of the step S2307.

In the step S2305, the program 123 adds a specified file and the capacity to a specified file list. More specifically, the program 123 stores a file name, a file capacity, a file type (a directory or a file) of the specified file, whether a duplicated deletion has been executed to the file (that is, the specified file is a clone target file or a normal file) into the memory 11 on a temporary basis in order to display them on the specified file list for instance.

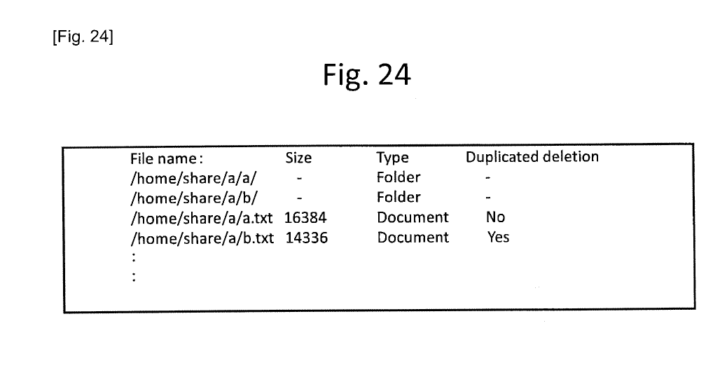

In the step S2307, the program 123 displays the specified file list and terminates the processing. An example of the specified file list is shown in FIG. 24.

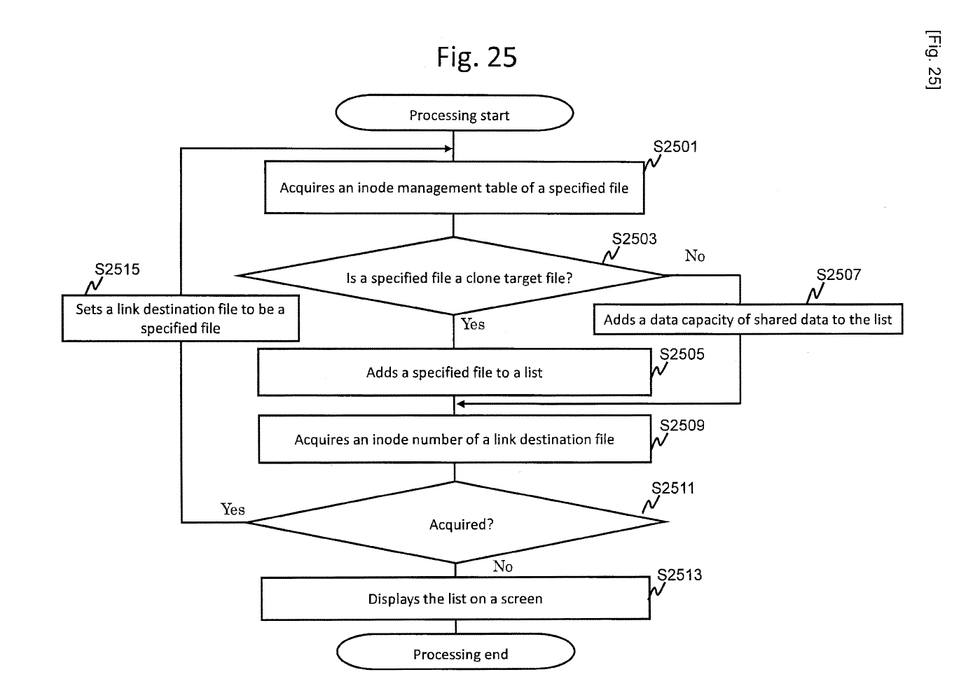

FIG. 25 is a view showing a flow of a second processing of a file group processing in accordance with an embodiment 3 of the present invention. In the following description, a clone target file is specified by a user from a file group list that has been displayed in the first processing.

In the step S2501, the program 123 acquires an inode management table 400 of an arbitrary clone target file that has been specified by a user (hereafter referred to as a specified file in the description of this figure) from a file group list that has been displayed (see FIG. 24).

In the step S2503, the program 123 judges whether a specified file is a clone target file or a clone source file. More specifically, the program 123 judges whether or not a number has been set to a clone source inode number 601 of an inode management table 400 that has been acquired for instance. In the case in which a specified file is a clone target file as a result of the judgment (Yes for the step S2503), the program 123 proceeds to the processing of the step S2505. On the other hand, in the case in which the specified file is a clone source file as a result of the judgment (No for the step S2503), the program 123 proceeds to the processing of the step S2507.

In the step S2505, the program 123 adds a specified file and the capacity to a list. More specifically, the program 123 stores a file name, an inode number, and a file capacity of the specified file into the memory 11 on a temporary basis in order to display them on the file group list for instance.

In the step S2507, the program 123 adds a specified file and the capacity to a list. More specifically, the program 123 stores a file name, an inode number, and a capacity of the shared data that is held by the file into the memory 11 on a temporary basis in order to display them on the file group list for instance.

In the step S2509, the program 123 acquires an inode number (an inode number (clone next) 603) of the link destination file of the specified file.

In the step S2511, the program 123 judges whether or not an inode number of a link destination file of the specified file has been acquired. In the case in which an inode number of a link destination file of the specified file has been acquired as a result of the judgment (Yes for the step S2511), the program 123 proceeds to the processing of the step S2515. On the other hand, in the case in which an inode number of a link destination file of the specified file has not been acquired (No for the step S2511), the program 123 proceeds to the processing of the step S2513.

In the step S2515, the program 123 sets the link destination file to be a specified file and proceeds to the processing of the step S2501.

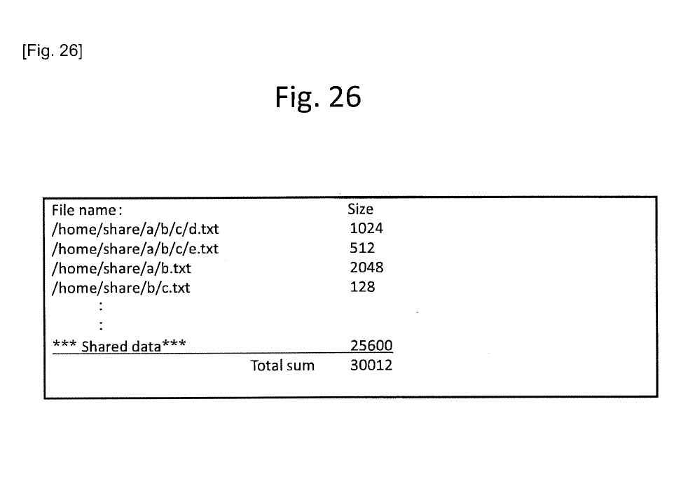

In the step S2513, the program 123 displays the file group list. An example of the file group list is shown in FIG. 26. In the example shown in the figure, a file name of a plurality of clone target files that configure the file group, a file capacity, a capacity of the shared data of the file group, the total sum of the capacity of the file group are displayed.

For the above file group display processing in accordance with the present embodiment, a user can know whether or not the file that has been specified by a user is a clone target file. In the case in which a user wants to delete a file group to which the specified clone target file belongs, the user can know a capacity that can be ensured in the case in which the file group is deleted. By this configuration, the user can delete a file of a desired capacity in an appropriate manner.

### Embodiment 4

Next, an embodiment 4 of the present invention will be described in detail with reference to the drawings. In this case, the points that are different from the embodiment 1 (to 3) will be described in large part, and the descriptions of the points that are common to the embodiment 1 (to 3) will be omitted or simplified.

A file update processing in accordance with the embodiment 4 is implemented in the case in which the file update program 127 is executed by the CPU 12.

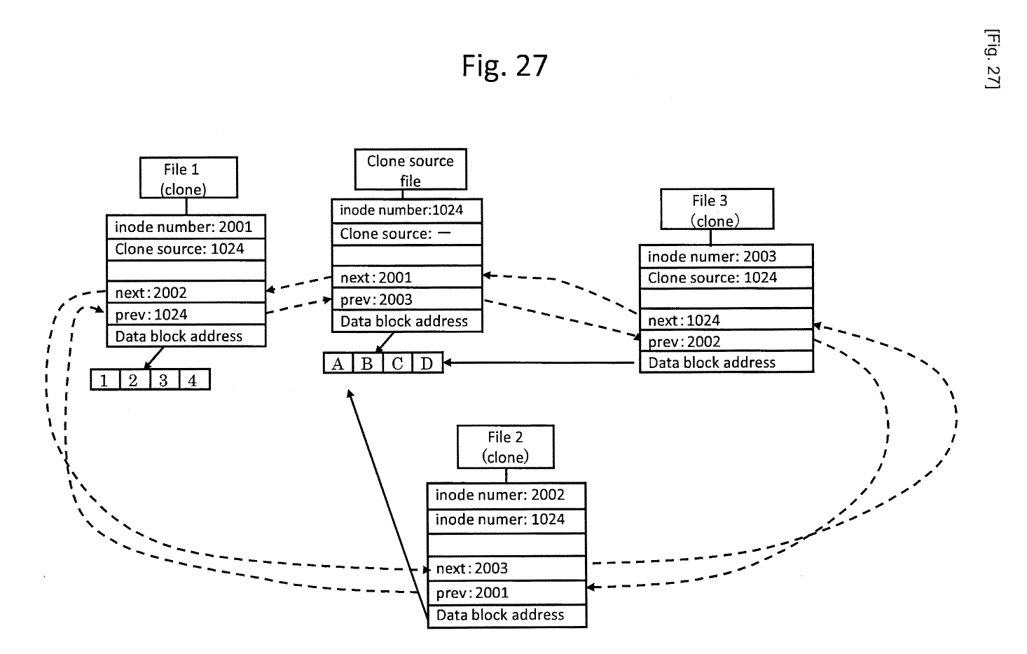

FIG. 27 is an explanatory drawing of a problem that is a premise of a file update processing.

In the case in which data is updated to a clone target file, the clone target file does not refer to the shared data for the data that has been updated and manages the data as differential data. Consequently, in the case in which data is updated, the clone target file does not refer to the shared data of a clone source file, or the number of data blocks that are referred to is equal to or less than a predetermined number in some cases. In the example shown in the figure, the file group is configured by a clone source file, a file 1, a file 2, and a file 3. The file 1, the file 2, and the file 3 have referred to a data block of a clone source file (shared data: A, B, C, and D). However, the file 1 becomes data that is entirely different from the shared data of the clone source file (differential data: 1, 2, 3, and 4) by the data update. In the case in which the file group deletion processing described above is executed in this case, a clone target file that does not refer to the shared data (file 1) is also deleted. Based on such a problem, in the case in which the number of references of the shared data of an update target file is equal to or less than a predetermined number after a data update for the file update processing, the update target file is deleted from the file group.

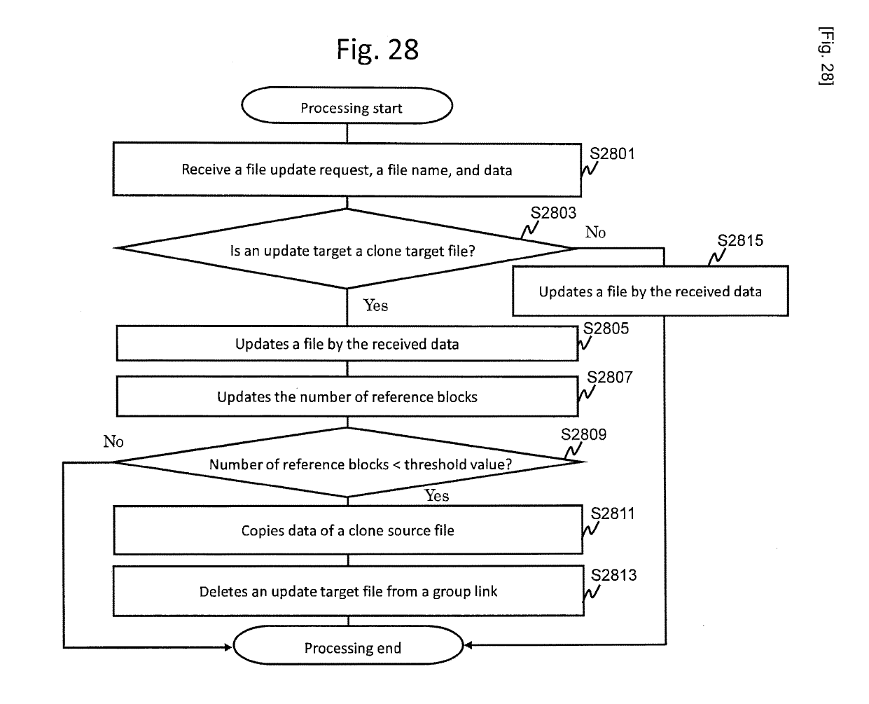

FIG. 28 is a view showing a flow of a file update processing in accordance with the present invention.

In the step S2801, the program 127 receives a file update request, a file name and the update data of an update target file from the client 10.

In the step S2803, the program 127 judges whether an update target file is a clone target file or not. In the case in which an update target file is a clone target file as a result of the judgment (Yes for the step S2803), the program 127 proceeds to the processing of the step S2805. On the other hand, in the case in which an update target file is not a clone target file (No for the step S2803), that is, an update target file is a normal file as a result of the judgment, the program 127 proceeds to the processing of the step S2815.

In the step S2815, the program 127 updates data of the update target file by the update data that has been received in the step S2801 and terminates the processing.

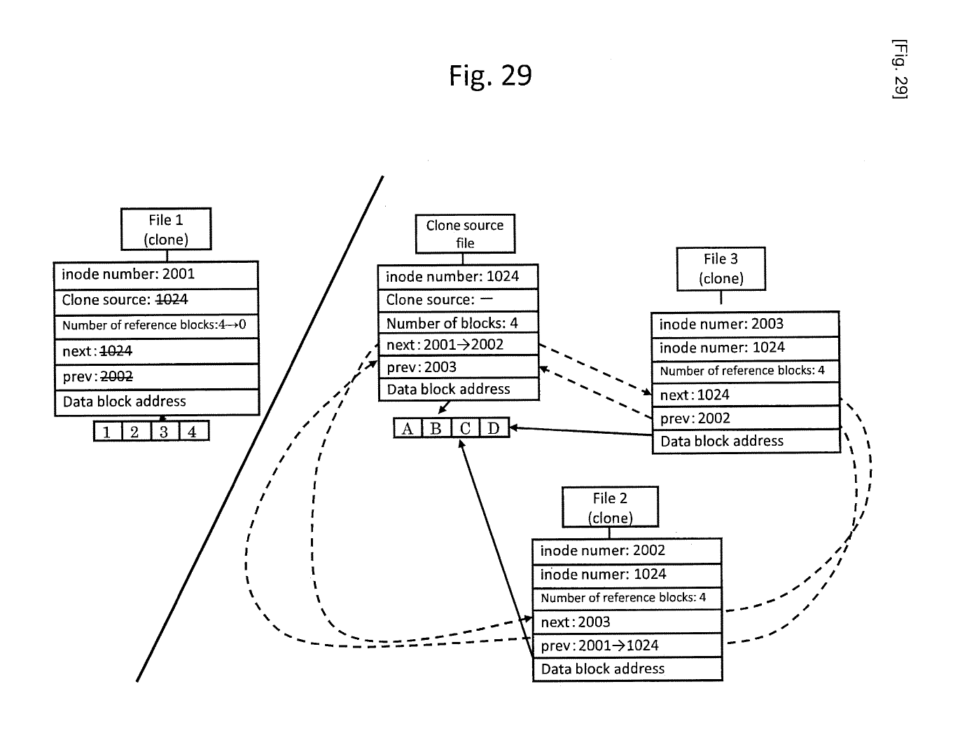

In the step S2805, the program 127 updates data of the update target file by the update data that has been received in the step S2801. More specifically for instance, in the example shown in FIG. 29, data of the file 1 (data has referred to the shared data (A, B, C, and D) of the clone source file) is updated by the update data (1, 2, 3, and 4). In this case, the file 1 stores the update data as differential data into a data block that is managed by the file 1.

In the step S2807, the program 127 updates a reference block number 604 of an inode management table 400. More specifically for instance, in the example shown in FIG. 29, since the file 1 updates all of the four data (A, B, C, and D) that has referred to the clone source file, the reference block number 604 is modified from 4 to 0.

In the step S2809, the program 127 judges whether or not a rate of the differential data to the shared data is less than a threshold value. More specifically, the program 127 judges whether or not a reference block number 604 of an inode management table 400 is less than a threshold value. The threshold value can be set by a user at the discretion of the user. In the case in which a reference block number 604 of an inode management table 400 is less than a threshold value as a result of the judgment (Yes for the step S2809), the program 127 proceeds to the processing of the step S2811. On the other hand, in the case in which a reference block number 604 of an inode management table 400 is equal to or larger than a threshold value as a result of the judgment (No for the step S2309), the program 123 terminates the processing.

In the step S2811, in the case in which there is data of a data block of a file source that is referred to by the update target file (data that is the shared data after an update), the program 127 copies the shared data to the data block of the update target file.

In the step S2813, the program 127 deletes the update target file from a group link and terminates the processing. More specifically for instance, in the example shown in FIG. 29, the program 127 deletes a clone source inode number 601 of the inode management table 400, an inode number (clone prev) 602, and an inode (clone next) 603 for the file 1.

In the above file update processing, the clone target file that is not so associated with the shared data of the clone source file is deleted from the file group by an update of data, thereby preventing the clone target file from being deleted in the file group deletion processing.

In the above example, in the case in which a reference block number of the clone source file is less than a threshold value, the update target file is deleted from the group link. However, it is not necessary that a target to be compared is a reference block number. For instance, a target to be compared can also be a rate of “a value that is obtained by adding the number of data blocks of the shared data to the number of data blocks that become differential data by an update” to “a data block number that becomes differential data by an update”. Moreover for instance, a target to be compared can also be a rate of a capacity of differential data to a capacity of the shared data.

### Embodiment 5

Next, an embodiment 5 of the present invention will be described in detail with reference to the drawings. In this case, the points that are different from the embodiment 1 (to 4) will be described in large part, and the descriptions of the points that are common to the embodiment 1 (to 4) will be omitted or simplified.

A shared data deletion processing in accordance with the embodiment 5 is implemented in the case in which the shared data deletion program 129 is executed by the CPU 12.

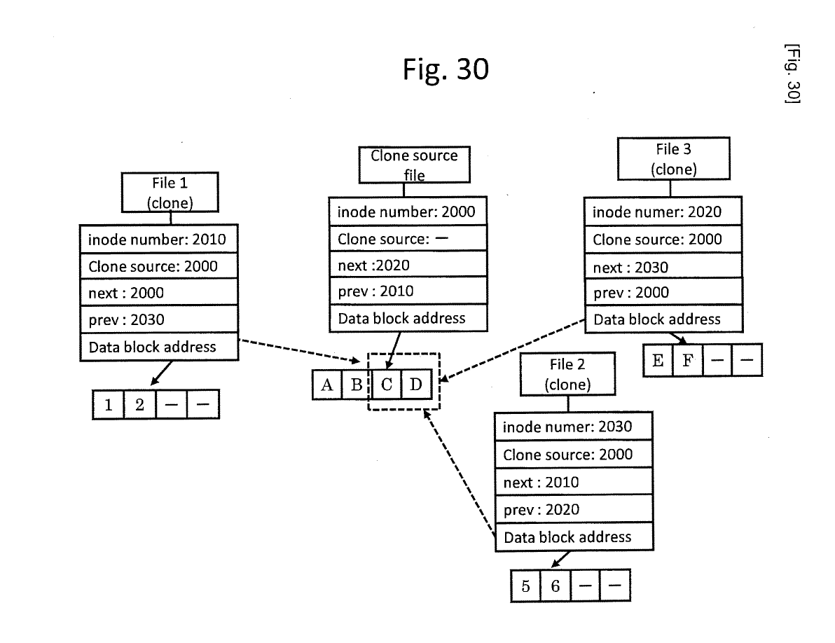

FIG. 30 is an explanatory drawing of a problem that is a premise of a shared data deletion processing.

In the above file update processing, a data block that is not referred to by any clone target file is generated in a clone source file in some cases. In the example shown in the figure, as a result of the update, the clone target files (the file 1, the file 2, and the file 3) refer to only data (data: C and D) that is a part of the clone source file and the data (A and B) is not referred to. In this case, although the data (A and B) is not referred to by any file, the data (A and B) exists until the data is deleted by the file group deletion processing, whereby a data region is consumed more than is necessary. The shared data deletion processing is executed to solve such a problem. The processing can also be executed on a regular basis.

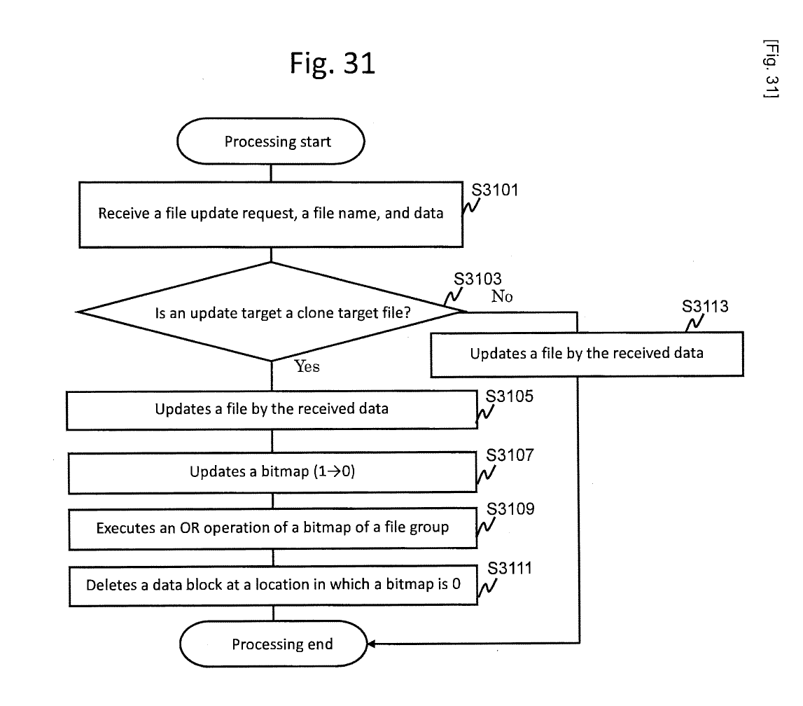

FIG. 31 is a view showing a flow of a shared data deletion processing.

In the step S3101, the program 129 receives a file update request, a file name and the update data of an update target file from the client 10.

In the step S3103, the program 129 judges whether an update target file is a clone target file or not. In the case in which an update target file is a clone target file as a result of the judgment (Yes for the step S3103), the program 129 proceeds to the processing of the step S3105. On the other hand, in the case in which an update target file is not a clone target file (No for the step S3103), that is, an update target file is a normal file as a result of the judgment, the program 129 proceeds to the processing of the step S3113.

In the step S3113, the program 129 updates a data block in the update target file by the update data that has been received in the step S3101 and terminates the processing.

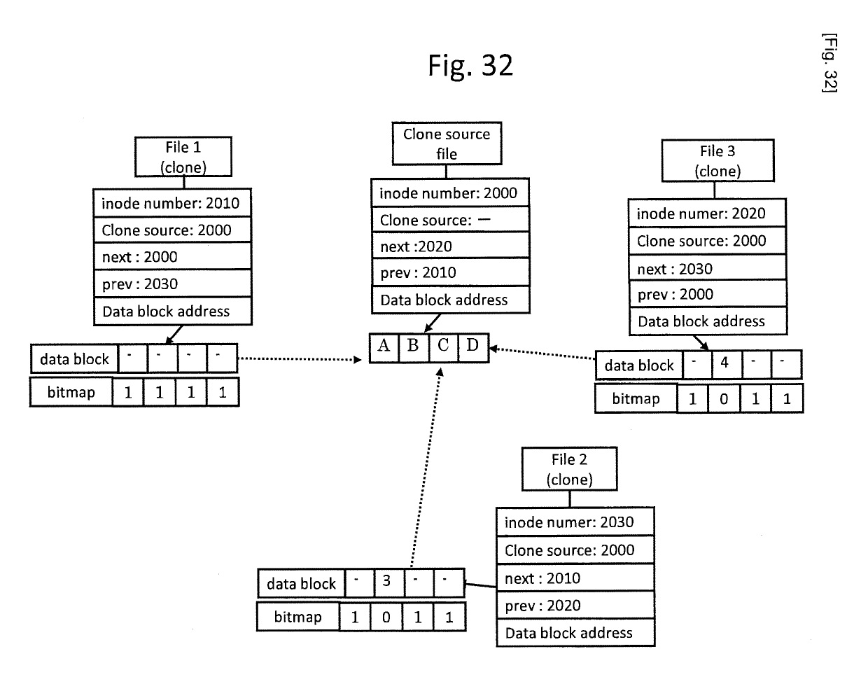

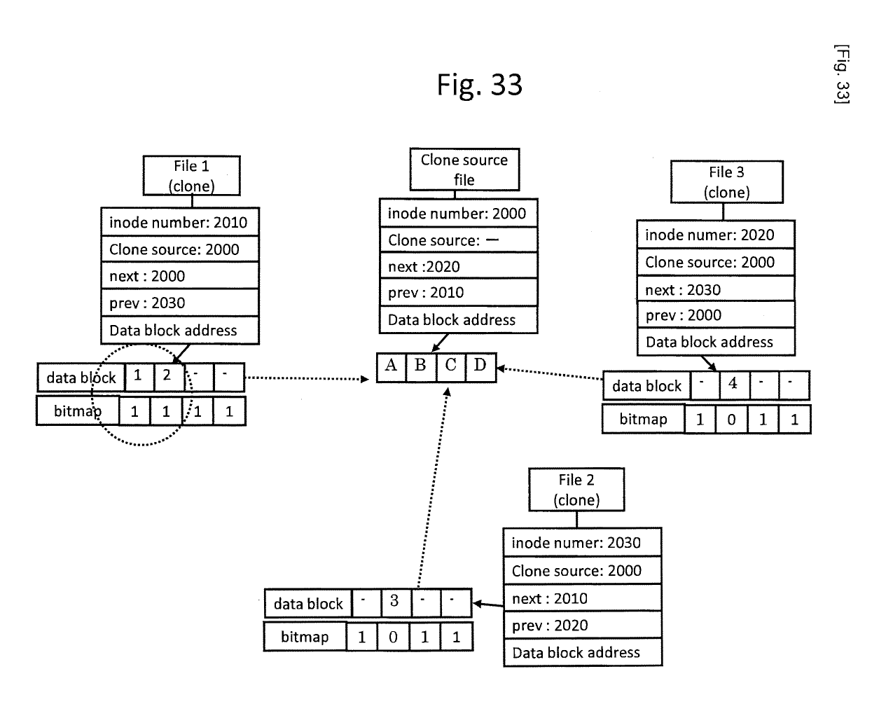

In the step S3105, the program 129 updates the data block of the update target file by the update data that has been received in the step S3101. More specifically, the step will be described while using the example shown in FIG. 31 and FIG. 32. FIG. 31 is a view showing a file group before the data update. The file 1 has not been updated and refers to four data blocks (data: A, B, C, and D) of the clone source file. For the file 2, the data block that is second from a left (data: 3) has been updated and refers to the remaining three data blocks (shared data: A, C, and D). For the file 3, the data block that is second from a left (data: 4) has been updated and refers to the remaining three shared data blocks (shared data: A, C, and D). FIG. 33 is a view showing a file group after the data update. The program 129 updates the data that is first from a left of the file 1 and the data that is second from a left of the file 1 to be the data 1 and the data 2, respectively.

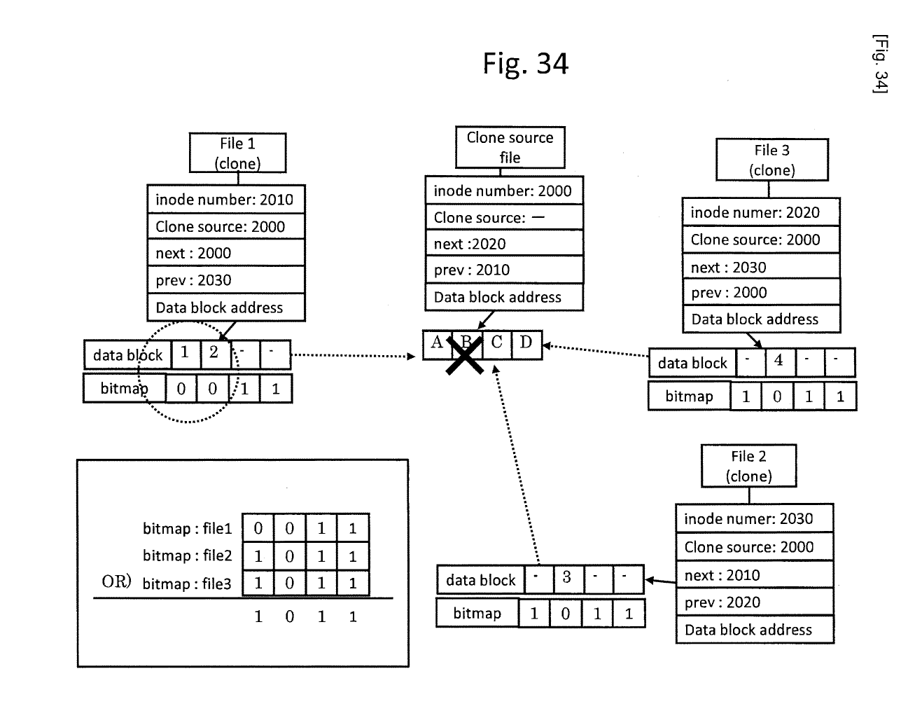

In the step S3107, the program 129 updates a bitmap that is corresponded to the data that has been updated. Each data block of the clone target file is corresponded to the bitmap. In the case in which each data block refers to a data block of the shared data, the bitmap is set to be 1. In the case in which data is updated, the bitmap that is corresponded to the data block is set to be 0. An example shown in FIG. 34 will be described more specifically. The program 129 modifies the bitmap that is corresponded to the data block that is provided with data that has been updated in the step S3105 (the data block that is first from a left and the data block that is second from a left) from 1 to 0.

In the step S3109, the program 129 detects a data block that is not referred to. More specifically for instance, the program 129 executes OR of each data block of a clone target file in a file group. An example shown in FIG. 34 will be described more specifically. An OR operation of the data block that is first from a left, the data block that is second from a left, the data block that is third from a left, and the data block that is fourth from a left is executed. An operation result of the data block that is second from a left is 0, and an operation result of other blocks is 1.

In the step S3111, the program 129 deletes data in a data block that is corresponded to a location in which an operation result is 0 for a bitmap in the step S3109 for a data block of the clone source file. An example shown in FIG. 34 will be described more specifically. The data of the clone source file (data: B) that is corresponded to the data block that is second from a left in which an operation result is 0 is deleted.

The shared data that is not referred to can be detected and deleted for every data block by a data update for the above shared data deletion processing. By this configuration, the unnecessary data that is not referred to from the clone target file can be less, and a storage region can be used in an effective manner.

While the some preferred embodiments in accordance with the present invention have been described above, the embodiments are examples for describing the present invention and the range of the present invention is not restricted to the embodiments. The present invention can also be implemented in various modes of other types.

Although data is stored into a data block in the above embodiments for instance, the present invention is not restricted to the embodiments.

Moreover, although the clone source file is provided with the shared data and the clone target file refers to the shared data in the above embodiments for instance, the clone target file can also be provided with the shared data. Moreover, although the duplicated data is copied to a data block of the clone source file in the case in which the shared data is created for instance, only one data can also be referred to without executing a copy processing.

Moreover, although a bitmap is used to manage whether or not data is updated in the above embodiments for instance, the present invention is not restricted to the embodiments and the update can also be managed by other methods.

### REFERENCE SIGNS LIST

10: File storage apparatus
20: Client
30: RAID system

1. A file server comprising:
a communication interface device that is coupled to a physical storage device that is a basis of a logical storage device configured by a plurality of logical regions;
a controller that is coupled to the communication interface device and configured to manage file system information that includes information indicating a logical region and data of a file that has been stored into the logical region; and
a client terminal coupled to the communication interface device,
wherein the controller is configured to:
identify m files (where m is equal to or larger than 2), each of the m files including duplicated data among a plurality of files that have been stored into the logical storage device as a file group based on the file system information;
delete copies of the duplicated data other than shared data, the shared data being one copy of the duplicated data included in the m files from the logical storage device;
make a file, which is not a shared file of the file group, referring to the shared file that is a file configured by the shared data;
create a group link that associates the m files that belong to the file group with each other;
store, upon the communication interface device receiving an update request of the duplicated data to a file that is an update target from the client terminal, data that conforms to the received update request into the logical storage device;
associate the data as differential data with the file system information of the file that is an update target; and
delete the file that is the update target from the group link when a rate of a capacity of the differential data to the shared data is equal to or less than the threshold value.

2. The file server according to claim 1, wherein the group link is a circular link in which the m files are nodes.

3. The file server according to claim 2, wherein a link between files for the group link is a bidirectional link.

4. The file server according to claim 1, wherein:
a client terminal is coupled to the communication interface device,
the communication interface device is configured to receive a deletion request of a file from the client terminal, and
the controller is configured to identify the group link that includes a deletion target file that is a target of the deletion request among a plurality of files that have been stored into the logical storage device and execute a deletion processing for deleting all files that belong to the identified group link.

5. The file server according to claim 4, wherein the controller is configured to make the client terminal display a file name and a file capacity of a file that has been deleted by the deletion processing based on the file system information when the deletion processing is executed.

6. The file server according to claim 1, wherein:
the file system information includes information that indicates whether or not the duplicated data of a file has been deleted,
a client terminal is coupled to the communication interface device,
the communication interface device is configured to receive an instruction of displaying a file from the client terminal, and
the controller is configured to make the client terminal display a file name of a file of a target of the received instruction and the information that indicates whether or not the duplicated data has been deleted based on the file system information.

7. The file server according to claim 6, wherein:
the file system information further includes the information that indicates a file capacity of a file,
the communication interface device is configured to receive a display request of a file capacity from the client terminal, and
the controller is configured to make the client terminal display a file name and a file capacity of each of files that belong to a group link that includes a file of a target of the display request based on the file system information.

8. (canceled)

9. The file server according to claim 1, wherein:
a client terminal is coupled to the communication interface device,
the communication interface device is configured to receive an update request of the duplicated data to a file that is an update target from the client terminal, and
the controller is configured to store data that conforms to the received update request into one or a plurality of logical regions, associate the data as differential data with the file system information of the file that is an update target, and delete the data in a logical region when the logical region is not referred to for logical regions that store the shared data.

10. A method comprising the steps of:
identifying m files (where m is equal to or larger than 2), each of the m files including duplicated data among a plurality of files that have been stored into a logical storage device as a file group based on the file system information that includes information that indicates a logical region and data of a file that has been stored into the logical region for a logical storage device that is configured by a plurality of logical regions;
deleting copies of the duplicated data other than shared data, the shared data being one copy of the duplicated data included in the m files from the logical storage device;
making a file, which is not a shared file of the file group, referring to the shared file that is a file configured by the shared data;
creating a group link that associates the m files that belong to the file group with each other;
receiving an update request of the duplicated data to a file that is an update target from a client terminal;
storing data that conforms to the received update request into the logical storage device;
associating the data as differential data with the file system information of the file that is an update target; and
deleting the file that is the update target from the group link when a rate of a capacity of the differential data to the shared data is equal to or less than the threshold value.

11. A non-transitory computer readable medium having a computer program stored therein, the computer program being executed by a computer to cause the computer to execute steps comprising the steps of:
identifying m files (where m is equal to or larger than 2), each of the m files including duplicated data among a plurality of files that have been stored into a logical storage device as a file group based on the file system information that includes information that indicates a logical region and data of a file that has been stored into the logical region for a logical storage device that is configured by a plurality of logical regions;
deleting copies of the duplicated data other than shared data, the shared data being one copy of the duplicated data included in the m files from the logical storage device;
making a file, which is not a shared file of the file group, referring to the shared file that is a file configured by the shared data;
creating a group link that associates the m files that belong to the file group with each other;
receiving an update request of the duplicated data to a file that is an update target from a client terminal;
storing data that conforms to the received update request into the logical storage device;
associating the data as differential data with the file system information of the file that is an update target; and
deleting the file that is the update target from the group link when a rate of a capacity of the differential data to the shared data is equal to or less than the threshold value.
